(19) United States
(12) Patent Application Publication
(10) Pub. No.: US 2008/0189748 A1
(43) Pub. Date: Aug. 7, 2008

(54) Aircraft video display unit and system

(75) Inventors: Brett Bleacher, Rancho Santa Margarita, CA (US); Mark Thompson, Rancho Santa Margarita, CA (US); Ton Do, Corona, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/879,985

(22) Filed: Jul. 19, 2007

Related U.S. Application Data
(60) Provisional application No. 60/807,947, filed on Jul. 21, 2006.

(51) Int. Cl. H04N 7/18

(52) U.S. Cl. 725/76

(57) ABSTRACT

A video display unit includes a housing coupled to a portion of an aircraft cabin, a local area network interface disposed at least partially within the housing, and a video decoder disposed within the housing. The video decoder receives video content via the network interface, and decodes the video content. The video display unit also has a display screen coupled to the housing. The display screen displays the video content, and allows a passenger to interact with the display in response to on-screen instructions, including the use of a magnetic card reader to, for example, purchase an item via credit card.

### CROSS-REFERENCE TO RELATED APPLICATIONS

This application claims the benefit of U.S. Provisional Application No. 60/807,947, filed Jul. 21, 2006, the entire content being incorporated herein by reference.

Related subject matter is disclosed in U.S. Application No. 11/137,011, filed May 25, 2005, and in U.S. Provisional Application No. 60/547,897, filed May 27, 2004, which are incorporated herein by reference in their entirety.

### TECHNICAL FIELD

This invention relates generally to in-flight entertainment systems, and, more particularly, in-flight entertainment system that have passenger video display units that are linked to a network.

### BACKGROUND

The air travel business is becoming increasingly competitive and commoditized, with travelers choosing among airlines largely based on price. To stay in business, airlines need to control costs. However, they still need to offer certain in-flight amenities, since passengers have grown to expect such service. An example of such an amenity is in-flight entertainment. Passengers generally expect to be shown at least one movie on a flight lasting more than a couple of hours. One problem with offering conventional in-flight movies, however, is that all passengers are shown the same movie, but not all passengers have the same viewing tastes. Additionally, children, who are the most restless passengers on any flight, are not interested in films for mature viewers. Thus, airlines are forced to pick movies that will hopefully have a broad appeal, while ignoring better movies that at least some passengers would prefer to see. Passengers with more discerning tastes are thus forced to bring their own personal movie players and video content, hoping that their batteries last for the duration of the flight. Another problem is that not all passengers even want to watch movies. Many passengers would prefer to pass the time browsing the Internet, playing video games, or shopping for goods offered during the flight. Again, passengers wishing to entertain themselves with these alternatives are forced to bring their own devices. Thus, it can be seen that there is a need for an aircraft video display unit that addresses the foregoing problems.

### SUMMARY

In accordance with the foregoing, an aircraft passenger video display unit is provided. An embodiment of the video display unit will now be described. In this embodiment, the video display unit includes a housing coupled to a portion of an aircraft cabin, a local area network interface disposed at least partially within the housing, and a video decoder disposed within the housing. The video decoder receives video content via the network interface, and decodes the video content. The video display unit also has a display screen coupled to the housing. The display screen displays the decoded video content, and displays a prompt indicating that a passenger should insert a magnetic card. The video display unit also has a magnetic card reader coupled to the housing. The magnetic card reader receives the magnetic card, reads data from the magnetic card (which may be a credit card), and transmits the read data through the network interface. The video content may describe an item for sale, the data from the magnetic card that is transmitted through the network interface may include data that enables a passenger using the display unit to purchase the item.

In one implementation, the video display has a touch screen interface coupled to the display screen. The touch screen interface receives the passenger's selection of the video content.

In another implementation, the video display unit has a magnetic sensor coupled to the housing that generates a signal whenever it senses a magnetic field, and a backlight coupled to the display screen. The video display unit turns the backlight off when it detects the signal generated by the magnetic sensor for at least a predetermined period of time.

In yet another implementation, the video display unit has an audio interface that receives the connection of a headset.

In still another implementation, the video display unit has an Ethernet switch disposed within the housing, and Ethernet ports exposed to the exterior of the housing, each of which is communicatively linked to the Ethernet switch.

In still another implementation, the video display unit has a wireless antenna interface built into the housing whereby the wireless antenna is exposed to the exterior of the housing, each of which is linked to the internal processor for wireless communication of video, audio and data.

In still another implementation, the video display unit has an infrared transceiver that receives infrared signals representing a selection by the passenger of one of a multiple selections from a user interface displayed on the display screen, converts the infrared signals into electrical signals, and transmits the electrical signals. In this implementation, the video display unit also has a processor that receives the electrical signals, and transmits data representing the user selection via the network interface.

In still another implementation, the video display unit has an external drive interface.

In still another implementation, the video display unit has a serial data port through which it receives kernel software. The video display unit receives application software code via the network interface.

Another embodiment of the invention will now be described. In this embodiment a system for displaying video content to an aircraft passenger includes a video display unit attached to an interior portion of an aircraft. The video display unit has a display screen, a local area network interface, and an infrared transceiver. The video display unit displays a user interface on the display screen, receives, via the infrared transceiver, signals indicating a user selection of an item from the user interface, and transmits, via the network interface, data that is based at least in part on the user selection. In this embodiment, the system includes a passenger control unit comprising an infrared transmitter. The passenger control unit receives a user input representing the user selection, and transmits the signals indicating the user selection to the video display unit.

In one implementation, the system includes a local area network located on the aircraft, and a server communicatively linked to the network. Stored on the server is video content.

In another implementation, the video content includes a plurality of digitally formatted videos. The user selection represents one of the plurality of videos. The video display unit transmits data representing the user selection to the server, receives, via the network interface, the selected video, decodes the selected video, and displays the selected video on the display screen.

In yet another implementation, the video display unit is one of a several video display units, and the system further includes a seat electronics box that has a network switch communicatively linked to the local area network. Each of the video display units is communicatively linked to the seat electronics box via separate network links.

In still another implementation, the seat electronics box has an RF tap that converts data received over the local area network into RF signals, and an overhead display unit that receives the RF signals from the seat electronic box via the RF tap.

In still another implementation, the video display unit has a serial data port. In this implementation, the video display unit receives application software code via the network interface and receives kernel software code via the serial data port.

In still another implementation, the video display unit has a magnetic card reader that receives an inserted magnetic card, reads data from the magnetic card, and transmits the read data over the local area network through the network interface.

In still another implementation, the magnetic card is a credit card, and data transmitted over the local area network includes data for permitting a passenger to purchase video content.

Yet another embodiment of the invention will now be described. In this embodiment, a system for providing video content is located on-board an aircraft, and has multiple passenger seats, a local area network, multiple video display units (each located proximate to at least one of the passenger seats). Each video display unit in this embodiment has a display screen, a network interface communicatively linked to the local area network, a maintenance interface, and a printed circuit board having disposed thereon a processor. The processor executes instructions that enable the processor to decode video signals. The system also has a server communicatively linked to the local area network, which transmits encoded video signals over the local area network. Each of the video display units receives the encoded video signals via the network interface card. The processor decodes the encoded video signals. The video display unit displays the video content on the display screen. The video display unit in this embodiment also receives, via the maintenance interface, test signals. The video display unit transmits, via the maintenance interface, responses to the test signals representing the status of the printed circuit board.

### BRIEF DESCRIPTION OF THE DRAWINGS

FIG. 1 illustrates an example of a system in which a smart video display unit (SVDU) according to an embodiment of the invention operates;

FIG. 2 is a block diagram illustrating an embodiment of the SVDU;

FIG. 3 illustrates an embodiment of an area distribution (ADB) box (from FIG. 1);

FIG. 4 illustrates an embodiment of a seat electronics box (SEB) (from FIG. 1); and

FIG. 5 is a diagram illustrating the flow of data in an embodiment of the SVDU.

### DETAILED DESCRIPTION

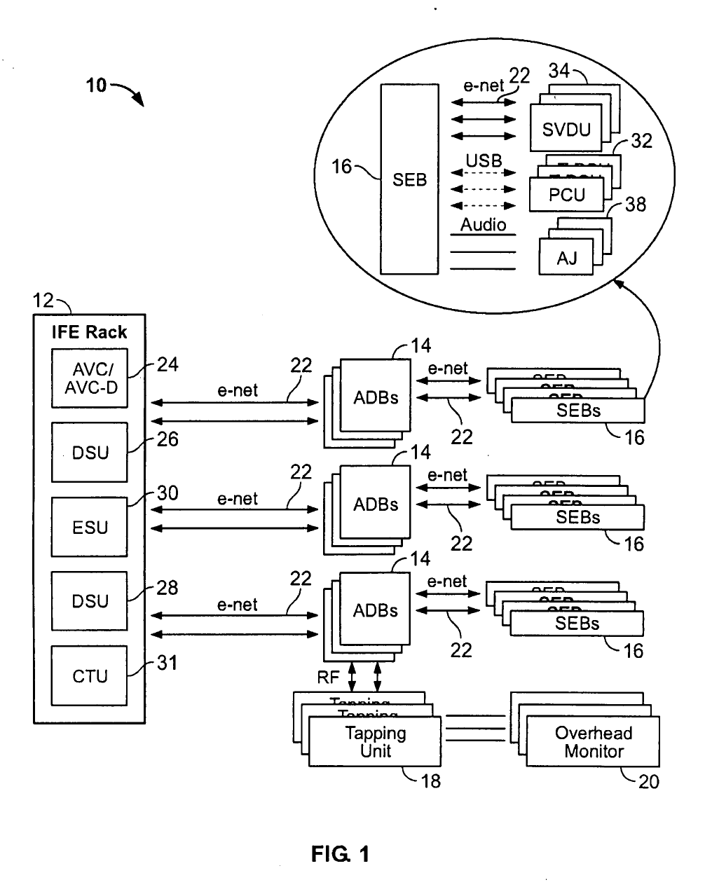

FIG. 1 illustrates a system in which a video display unit configured according to an embodiment of the invention is deployed. The system, generally labeled 10, includes an in-flight entertainment (IFE) rack 12, one or more area distribution boxes (ADBs) 14, one or more seat electronic boxes (SEBs) 16, one or more tapping units 18, one or more overhead monitors 20, and one or more Ethernet links 22. The IFE rack 12 contains either an audio-video controller (AVC) 24, with two digital server units (DSU) 26 and 28, with an Ethernet switching unit (ESU) 30, and a cabin terminal unit (CTU) 31 or a newer digital audio-video server unit (AVC-D) 24 with all the capabilities of the previous generation AVC, DSU and ESU combined and a cabin terminal unit (CTU) 31. The AVC or AVC-D 24 controls the delivery of audio and video content to the passengers, while the CTU 31 provides a terminal interface for the cabin crew to use. The components contained in the IFE rack are communicatively linked to the ADBs 14, via the Ethernet links 22, which switch through the ESU 30 or AVC-D 24. As shown in FIG. 1, several of the ADBs 14 are communicatively linked to the tapping units 18 via a radio frequency (RF) link. Each tapping unit 18 is, in turn, communicatively linked to an overhead monitor 20 via RF link. It is understood that the Ethernet links 22 may be wireless. Associated with each SEB 16 are passenger control units (PCU) 32 (communicatively linked to the SEB 16 via Universal Serial Bus (USB) or Ethernet), SVDUs 34 (communicatively linked to the SEB 16 via Ethernet link), and audio jacks (AJ) 38. In some embodiments, the PCUs 32 are wireless, contain wireless transmitters (such as an RF or IR transmitter) and communicate directly with the SVDU 34, instead of via the SEB 16. In various embodiments of the invention, all of the components depicted in FIG. 1 are located with a cabin of an aircraft. Naturally, the embodiments described herein can be employed in any type of vehicle, such as an aircraft, bus, train, ship, and so on.

According to an embodiment of the invention, the SVDU 34 is a terminal that a passenger can use to communicate over the system 10. The SVDU 34 may be mounted in a variety of locations in the cabin, such as on a seat-back, on an arm mount, or on the cabin wall. Each SVDU 34 includes a display screen and a housing with options such touch screen and magnetic card reader. The SVDU 34 is made out of materials selected so as to make it compliant with applicable aircraft regulations. For example, FR-4 material is used on circuit board assemblies. Exterior surfaces of the SVDU 34 are designed to withstand exposure to isopropyl alcohol, household ammonia, food acids (e.g. lemon juice and soft drinks) and commercial cleaning agents. Furthermore, all exterior surface finishes of the SVDU 34 are designed to withstand the abrasion of industrial cleaning pads soaked in commercial cleaning agents. Additionally, the SVDU 34 is designed in accordance with standard Human Engineering design criteria and principles so as to maximize safety, maintainability and reliability. In an embodiment of the invention, the SVDU 34 includes a liquid crystal display (LCD) that has a backlight. The SVDU 34 provides On Screen Display (OSD) capability on the LCD.

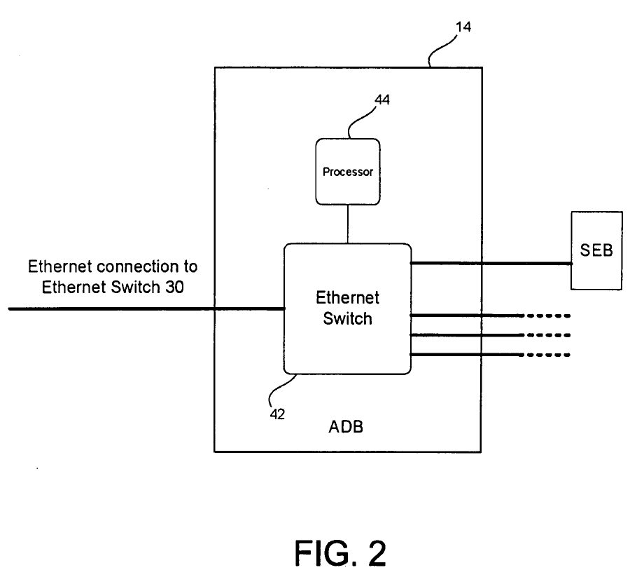

Referring to FIG. 2, an example implementation of an ADB 14 from FIG. 1 will now be described. According to this implementation, the ADB is controlled by a microprocessor 44 (e.g., a 300 MHz G3 PowerPC), and includes an Ethernet switch 42. The ADB is communicatively linked to the ESU 30 or AVC-D 24 (FIG. 1) via a 1000BaseT or fiberoptic Ethernet. The ADB is communicatively linked to some of the SEBs 28 (FIG. 1) in its subnet via Ethernet links (either 1000BaseT or 100BaseT). The ADB receives Ethernet frames from the ESU 30 or AVC-D 24 and transmits them to the appropriate SEBs based on the destination MAC addresses of the frames and based on multicast protocol commands received. Additionally, the ADB may be capable of detecting IP addresses of packets contained within the Ethernet frames and transmitting the Ethernet frames to the appropriate SEBs based on those IP addresses.

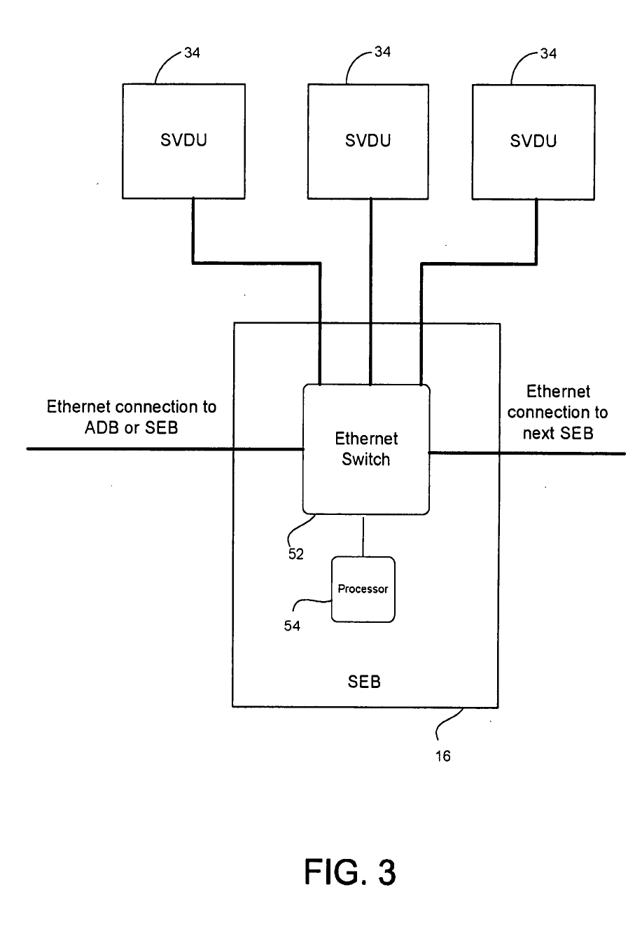

Referring to FIG. 3, an example implementation of an SEB 16 from FIG. 1 will now be described. According to this implementation, the SEB 16 is controlled by a microprocessor 54 (e.g., a 300 MHz G3 PowerPC), and includes an Ethernet switch 52. The SEB is communicatively linked to either the ESU or AVC-D 30 (FIG. 1) or another SEB via an Ethernet link (either 1000BaseT or 100BaseT). The SEB is also communicatively linked to first, second, third and possible forth SVDUs 34 via 1000BaseT or 100BaseT Ethernet. The SEB 16 receives Ethernet frames from the ESU 30 or AVC-D 24, either directly or via other SEBs, and transmits them to the appropriate digital video player based at least in part on the destination MAC addresses of the frames and based on multicast protocol commands received. Additionally, the SEB may be capable of detecting IP addresses of packets contained within the Ethernet frames and transmitting the Ethernet frames to the appropriate SVDUs 34 based on those IP addresses.

In one embodiment, the SVDU 34 (FIG. 1) has three major components: a liquid crystal display (LCD) with backlight and optional touch screen and/or magnetic card reader, a power interface printed circuit board (PCB) with backlight inverter power supply, and a processor printed circuit board (PCB), on which the main processor is located.

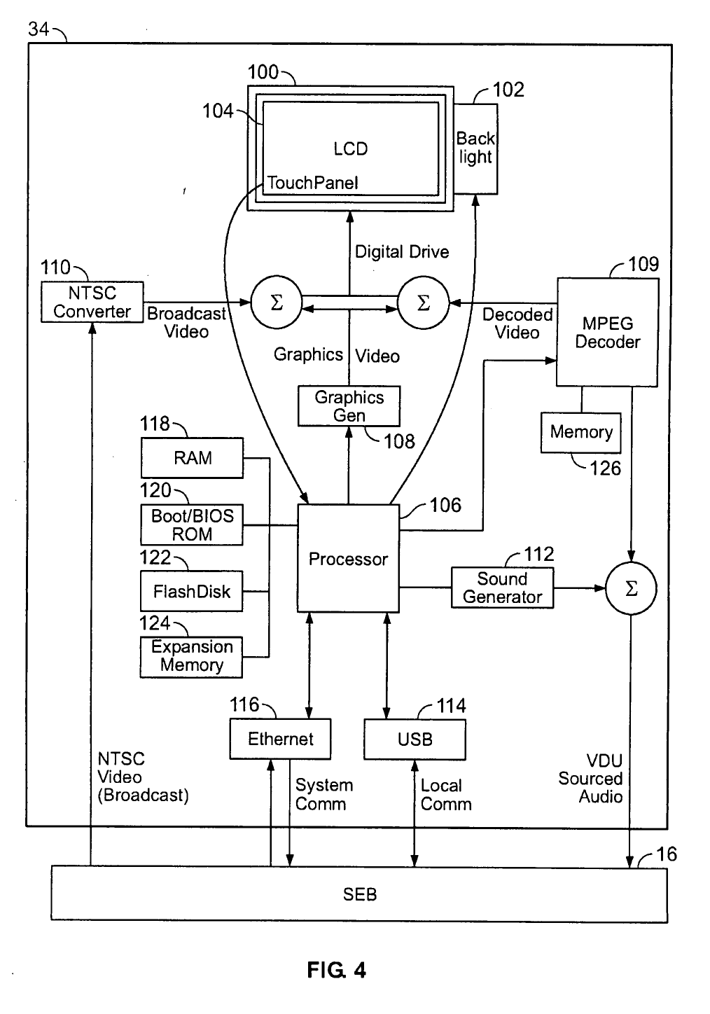

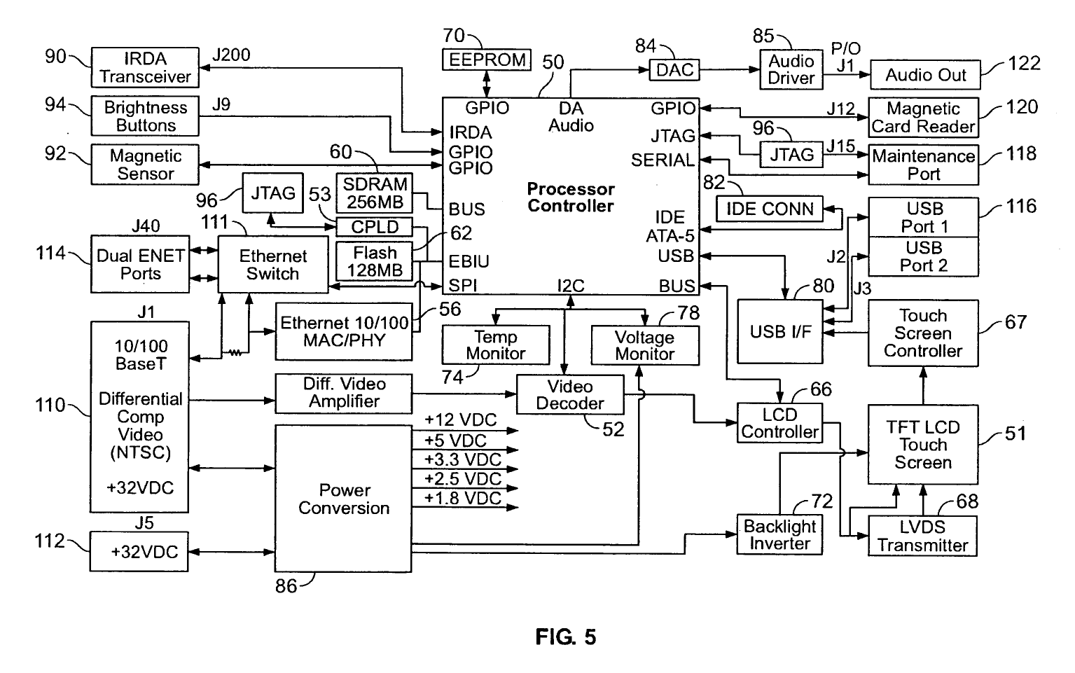

Referring to the block diagram of FIG. 4, a configuration of the SVDU 34 according to an embodiment of the invention will now be described. Some of the components illustrated in FIG. 4 also appear in FIG. 5 (albeit with different reference numbers), which will be discussed below. The SVDU 34 includes an LCD screen 100 lit by a backlight 102, and a touch panel 104. The SVDU 34 also includes a processor 106, a graphics generator 108, an MPEG decoder 109 or integrated MPEG Decoder with Processor 106, an NTSC converter 110, a sound generator 112, a USB interface 114, and an Ethernet interface 116. A RAM 118, Boot/Bios ROM 120, flash disk 122, and an expansion memory 124 are all communicatively linked to the processor 106. The MPEG decoder 109 has its own memory 126 as well.

Characteristics that the MPEG decoder 109 may have in an embodiment of the invention will now be described. The MPEG decoder 109 can decode material containing multiple languages and is able to select and decode a specific video and audio stream. The MPEG decoder 109 supports the decoding of MPEG material encoded at the following resolutions: MPEG-1 material at 352×240 (SIF), MPEG-2 material at 352×480 (Half D-1), and MPEG-2 material at 720×480 (Full D-1). The MPEG decoder 109 supports Constant Bit Rate (CBR) video at a rate of 1.5 Mbps for MPEG-1 material and up to 7 Mbps for MPEG-2 material. These bit rates are for the elemental video stream and do not include encoded audio, data, or multiplexing overhead.

The SVDU 34 further includes an MP3 Audio Decoder, which decodes compressed MP3 audio files by using an MPEG-1, Layer 3 decoding algorithm. The SVDU 34 supports the decoding of audio encoded per WAEA Specification 0395.

The SVDU 34 provides sound generation capability, and supports audio coded in wave, FM synthesis, and midi synthesis formats. Audio created within the SVDU 34 is provided to the SEB 16 (FIG. 3). The audio interface includes a Left audio signal (AudL) a right audio signal (AudR) and a common reference audio return (AudRtn). In one embodiment, the output impedance of the audio drivers is less than 50 Ohms, and a maximum volume signal produces an output level of 0 dBm into 600-Ohm (2.2 Vp-p) as specified in WAEA-1289-1 and WAEA-1289-2. The audio driver is capable of producing a +3 dBm signal for up to 10 msec without excessive clipping or distortion. The audio driver is also able to output 100 mV into 16-Ohm headset.

In general, the SVDU 34 has sufficient processing power, memory, graphics capability, and MPEG 1 & 2 decoding capability to act as a multimedia presentation device. The SVDU 34 presents information to a passenger, including NTSC-based video, internally generated graphics, and MPEG digital video and audio that it receives from various sources, including the first DSU 26 second DSU 28 or AVC-D 24, by way of the SEB 16 in FIG. 1. The system 10 (FIG. 1) presents video graphics, video-on-demand, audio-on-demand, local games, and web content to each passenger via the SVDU 34, which is located at or near the passenger's seat. Other types of content that may be delivered to the passengers on their SVDUs 34 includes satellite TV, digital radio, external internet (from an external provider), web portal access, eBook content, all types of MPEG content (including MPEG-4), picture in picture, voice over IP (VoIP), in-flight food menus, and in-flight shopping catalogs. This content may be obtained from electronic storage that is internal to the aircraft, from a land connection (when the aircraft is on the ground), or from various wireless connections, such as Swift-64 and Ku-band data communications. The SVDU 34 may decode MPEG-1, Layer II encoded at a rate of 128 kbps single channel or joint stereo. The SVDU should decode MPEG audio encoded at a rate of up to 256 kbps.

Each SVDU 34 may have a high-resolution touch panel 104 that is coupled to the display 100 of the SVDU 34 (see FIG. 4). The passenger can interact with and control the SVDU 34 through the touch panel. The SVDU 34 may be powered on whenever entertainment services are available to the passenger. When entertainment services are discontinued, such as during a safety demonstration by the flight crew, the power to the SVDU may be turned off via its corresponding SEB 16.

The Ethernet interface 116 permits the SVDU 34 to communicate with the other components of the system 10 via the Ethernet links 22. This interface supports 10BaseT as specified in IEEE802.3×, 100 BaseT as specified in IEEE802.3×, and can auto sense the operating speed as specified in IEEE802.3×. The SVDU 34 may support a variety of high-level and low-level networking protocols, including User Datagram Protocol (UDP), Transmission Control Protocol (TCP), and File Transfer Protocol (FTP). Furthermore, the application code for enabling the SVDU 34 to perform various functions is downloaded via the Ethernet interface 116 (e.g., by factory or maintenance personnel). In general, Ethernet communication may be used to provide control, status and BITE capabilities for the SVDU 34.

In an embodiment of the invention, each SVDU 34 can support two different MAC Addresses—a factory-assigned MAC address and a system-assigned MAC address. The factory assigned MAC address is stored in non-volatile memory of the SVDU 34 (such as the ROM 120 or flash disk 122), and remains unmodified for the life of the SVDU 34. In contrast, the system-assigned MAC address is stored in volatile memory (such as the RAM 118), and is assigned on each boot-up of the SVDU 34. The system-assigned MAC address may be modified by the system 10. To modify the system assigned MAC address, the system 10 sends out a “MAC address assignment message,” which the Ethernet controller in the SVDU 34 receives. The Ethernet interface 116 responds by modifying the current MAC address in volatile memory to match the MAC address indicated in the assignment message. Having a system assigned MAC address optimizes the performance of the system 10 (especially the ESU 30 or AVC-D 24). The SVDU 34 can also revert back to its factory assigned MAC address. To cause the SVDU 34 to revert back to its factory-assigned MAC address, the system 10 transmits a “Restore Factory MAC Address” message, which the Ethernet controller of the SVDU 34 receives. In response, the Ethernet interface 116 retrieves the factory-assigned MAC address from the non-volatile memory and stores it in volatile memory.

The SVDU 34 uses an Internet Protocol address to identify itself to the system 10. The SVDU 34 may use a default IP address of 192.x.x.x when no IP address has been provided by the system 10. To assign an IP address to the SVDU 34, the system 10 may perform an IP Sequencing process, an embodiment of which is described in U.S. patent application Ser. No. 11/058,037, filed Feb. 15, 2005, which is incorporated herein by reference in its entirety or DHCP (Dynamic Host Configuration Protocol). Once it receives an IP address from the system 10, the SVDU 34 stores the IP address in non-volatile memory. The system-assigned IP address is used by the SVDU 34 until the system 10 assigns a new IP address as a result of the IP Sequencing or DHCP process. Additional IP addresses may be adopted by specific software components (such as a web server) in the SVDU 34 via an IP aliasing function.

In various embodiments of the invention, the display of the SVDU 34 is a color LCD screen, and the SVDU 34 further includes a housing, internal hardware within the housing that receives power, NTSC (M) video, and Ethernet data (MPEG-1/MPEG-2 streaming video/audio) from the SEB 16 associated with the SVDU 34. The internal hardware of the SVDU 34 includes a power interface printed circuit board (PCB) with a backlight inverter power supply, and a processor printed circuit board (PCB).

Referring still to FIG. 4, the graphics generator 108 produces color graphic images for display on the LCD 100 at the following resolutions: 640×480, 800×600, 1024×768, 1024×600, 1280×768, and 1280×800. It is contemplated that not all implementations of the LCD 100 will be able to support these resolutions. Thus, the SVDU permits the selection of any of its available resolutions. Images of lower resolution (such as SIF [352×240] video images, etc.) are presented full screen on the LCD 100. The graphics generator 108 supports 16-bit color and 24-bit color. The graphics generator 108 also supports mule-format alpha-blending.

The SVDU 34 is also equipped with a local manual brightness control on its front. In one implementation, two buttons are provided on the front surface of the SVDU 34 to control the brightness of the LCD. One button increases the brightness, while the other decreases it. The surfaces of the buttons are sufficiently hard to prevent or minimize damage by the passenger. The SVDU 34 may also have a third button that turns the backlight 102 on or off. If the backlight 102 is off, the LCD 100 is turned on automatically by any other action that would normally require the backlight to be on.

The SVDU 34 also includes a connector into which a commercial, non-volatile memory component such as Compact Flash, SDRAM, or PCMCIA can be inserted. The connector is located such that it is not accessible to the passenger but can be easily accessed for insertion, exchange or removal by maintenance personnel.

In one embodiment, the software that executes on the SVDU 34 is divided into two classes: boot/basic input output software (BIOS) and aircraft-loadable software. Types of aircraft loadable software include core software, common application software, and customer-specific application software. An example of core software is Acceptance Test Procedure (ATP) software or its equivalent, which performs a complete verification of the internal hardware of the SVDU 34. An example of common application software is a web browser (such as Opera for Linux) for accessing and displaying menus, lists and other material formatted as HTML web pages. Another example of common application software that may be loaded onto the SVDU 34 and, in particular, used by the MPEG decoder 109, is a media player capable of playing MPEG material obtained from the one of the DSUs (FIG. 1). The media player, in conjunction with the hardware of the SVDU 34, is accessible from a browser window, and supports the requesting, buffering, demultiplexing, and decoding of either MPEG-1 or MPEG-2 material.

The ROM 120 includes the boot/BIOS software, which is capable of performing a basic set of functions, including address assignment (IP and MAC), configuration reporting (“Config Check”) and software download. The software download function is used to download the aircraft loadable software. Another example of software that may be stored in ROM includes software to allow the processor 106 to initialize the NTSC Video and MPEG-1/MPEG-2 Decoders at power up, monitor the built-in test equipment (BITE), and control the brightness. Of course, this software may be stored in RAM as well.

One possible configuration of the SVDU 34 will now be described with reference to FIG. 5. In the configuration shown in FIG. 5, the SVDU 34 includes several components, which are communicatively linked to one another by communication paths, designated by the arrow-headed lines. These components include a processor controller 50, an LCD touch screen 51, a video decoder 52, a flash memory 62, a liquid-crystal display (LCD) controller 66, a touch-screen controller 67, and an EEPROM 70. The processor controller 50 executes software that is stored in one or more of the various memory elements. For example, the processor controller 50 executes software of an operating system, such as Linux or Windows CE.

The SVDU 34 also includes a backlight inverter 72, and a temperature monitor 74. The temperature monitor 74 monitors the internal temperature of the SVDU 34. The backlight inverter 72 is connected to, and operates the backlight of the LCD to which the LCD touch screen 51 is coupled. In one embodiment, the touch screen 51 has an 8-wire interface. The SVDU 34 further includes a complex programmable logic device (CPLD) 53, an Ethernet controller 56 or an Ethernet Switch 111, a synchronous dynamic random-access memory (SDRAM) 60, a voltage monitor unit 78, a USB interface 80, an integrated drive electronics (IDE) connector 82, a digital to analog controller (DAC) 84, and an audio driver 85.

The video decoder 52 is an MPEG High Performance Video/Audio Decoder capable of both MPEG-1 and MPEG-2 video and audio decoding. It includes an Audio Decoder and a hardware MPEG-2 Transport Demultiplexer. Its features include video/audio synchronization, error detection, concealment, and notification. The video decoder 52 supports the demultiplexing of MPEG-2 system streams (as defined in ISO 13818-1). The video decoder 52 also supports the decoding of MPEG-2 Elementary Video and Audio Streams (as defined in ISO 13818-2) and MPEG-1 Video (as defined in ISO 11172-2) and audio (as defined in ISO 11172-3). Additionally, the video decoder supports video and audio encoded in accordance with WAEA Specification 0395. Also, the video decoder 52 can be configured to enable an embedded digital video broadcast (DVB) common descrambler that supports descrambling at either the transport level or the packetized elementary stream (PES) level. The SVDU 34 accepts a differential video input signal from the SEB 16 and, by using the video decoder 52, is capable of accepting and properly presenting NTSC video compliant with EIA-RS170, EIA-RS170A, EIA-RS343, and SMPTE170M. These presentation capabilities include horizontal and vertical video scaling for randomly sized windows and Closed Captioning.

Referring again to FIG. 5, the SVDU 34 includes a maintenance port 118 that communicates with a Joint Test Action Group (JTAG) interface 96. The JTAG interface 96 provides the capability to perform boundary scan testing of circuit boards of the SVDU 34 and allow in-system programming or reprogramming of hardware devices. A serial debug interface is incorporated into the JTAG interface 96. The debug interface provides debugging capability to the processor controller 50. A maintenance worker may, for example, hook up a notebook computer to the maintenance port (with the appropriate connector) and execute software in accordance with the IEEE 1149.1 standard. The notebook computer will send test signals through the maintenance port and receive signals back in response. Based on the received signals, the software running on the notebook computer can inform the maintenance worker as to any anomalies on the PCB (either the power interface PCB or the processor PCB).

In an embodiment of the invention, the SVDU 34, the SVDU provides BITE (Built-In Test Electronics) to test each of the following components during power up or maintenance modes: the SDRAM memory 60, the flash memory 62, the Ethernet interface 56, and the backlight inverter 72. The SVDU 34 records its elapsed ON time in non-volatile memory, such as the flash memory 62. The data elapsed ON time can be retrieved from the LCD monitor via an on-screen display or via Ethernet interface 56. A Kernel and Root File System (RFS) can be downloaded to the processor controller 50 and to the various memory components of the SVDU 34 via the JTAG interface 96. Application code may be downloaded via the Ethernet Interface 56. Ethernet communication is used to provide the control, status and BITE capabilities of the SVDU 34. In one embodiment, the processor controller 50 contains the programming code to allow it to initialize NTSC Video and MPEG-1/MPEG-2 decoders at power up, monitor the BITE, and control the brightness of the LCD backlight.

Referring again to FIG. 5, the SVDU 34 has a power conversion unit 86, which receives unregulated +32VDC 112 from the SEB 16 and converts it to 1.8VDC±5%, +2.5VDC+5%, +3.3VDC±5%, +5.0VDC±5%, and +12VDC+5% regulated for use by the electronics of the LCD and its associated printed circuit board. A reset signal is provided to the processor controller 50 at power-on and when the +3.3VDC drops below 12%.

Referring still to FIG. 5, the SVDU 34 further includes an LVDS transmitter 68 linked to the LCD controller 66. The LCD controller 66 converts RGB signals from the video decoder 52. The LVDS transmitter 68 converts 24-bit RGB digital data received from the LCD controller 66 into three LVDS data streams. The LVDS transmitter minimizes the EMI and cable size problems commonly associated with wide, high speed TTL interfaces.

The SVDU 34 further includes an infrared data association (IrDA) transceiver 90 that receives infrared signals, such as from an infrared-based handheld passenger control unit (PCU), and encodes the data contained in those infrared signals into electrical signals, and vice versa. The system 10 (FIG. 1) assigns the SVDU 34 an infrared database address based on the IP address of the SVDU 34. The IrDA transceiver 90 is mounted in front of the SVDU 34 to allow a clear path to the remote IR sender control unit. In one embodiment, a passenger uses an IR-based PCU to make a selection from an on-screen user interface displayed on the display screen of the SVDU 34. As previously discussed, such a user interface may give the passenger the option to order video content such as movies, make meal selections, and shop for items (such as duty free goods).

The SVDU 34 also includes a magnetic sensor 92, which is mounted on the front of the SVDU 34. When the magnetic sensor 92 detects the presence of a magnetic field, it transmits a signal to the processor controller 50. When the processor controller 50 receives a signal from the magnetic sensor 92 for more than twenty seconds, the processor controller 50 commands the backlight of the LCD to turn off. Once the signal from the magnetic sensor 92 ceases, the processor controller 50 commands the backlight of the LCD to turn off. In some embodiments, the SVDU 34 is capable of being put into a stowed position in, for example, a recess in a seat back. Mounted in the recess is a magnet, such that when the SVDU 34 is stowed in the recess, the magnet comes into close proximity to the magnetic sensor 92, and the magnetic sensor 92 detects the magnetic field. Thus, the SVDU 34 automatically shuts off the LCD backlight when it is stowed, turns the backlight back on when it is unstowed.

Referring still to FIG. 5, the SVDU 34 includes brightness buttons that permit a passenger to control the brightness of the LCD backlight. In one embodiment, there are 16 steps from minimum brightness to maximum brightness. In some embodiments, the brightness is controlled via the touch screen 51.

Referring still to FIG. 5, various embodiments of the SVDU 34 support user input devices in addition to the touch screen 51. Examples include: a pointing device (local USB or remote), a game controller (Local USB or remote), a standard 84-key PC keyboard (Local USB or remote), and a magnetic card reader (with a detachable USB or RS232 connector) 120. If included, the magnetic card reader 120 will be modular and easily removed by maintenance and repair personnel. The magnetic card reader 120 may be capable of reading credit cards. In one embodiment, the SVDU 34 presents a user interface on the display screen showing a passenger a variety of items that the passenger can purchase. These items may include in-flight movies, in-flight merchandise (such as duty-free goods), in-flight food items, or the like. The user interface may, for example, prompt the passenger to insert his or her credit card into the card reader 120 (such as by swiping it). The card reader 120 then reads data from the credit card and transmits the data to one of the components of the IFE rack 12 (via the network interface of the SVDU 34 and the intervening network links, SEBs and ADBs) (FIG. 1), and the purchase is completed.

In various embodiments of the invention, the SVDU has connectors through which data and power are transmitted and received. Some of these connectors are identified in FIG. 5 (with ‘J’ numbers). Examples of how such connectors may be implemented will now be described. In one example, the connector J1 is the main input/output connector, whose pins are assigned as shown in Table 1.

TABLE 1
Main I/O Connector

| Pin Number | Signal Name | I/O Function Type |
|---|---|---|
| 1 | 32VRTN | Input Power Return |
| 2 | VID_HI | Differential Video Input+ |
| 3 | +32 V | Input Power |
| 4 | VID_LO | Differential Video Input− |
| 5 | RX_LO | Differential 10/100BaseT Input− |
| 6 | RX_HI | Differential 10/100BaseT Input+ |
| 7 | TX_LO | Differential 10/100Base T Output− |
| 8 | TX_HI | Differential 10/100BaseT Output+ |
| 9 | AUD_L | Audio Left Channel Output |
| 10 | AUD_R | Audio Right Channel Output |
| 11 | AUD_RTN | Audio Return |
| 12 | QUAL: SHIELD | Ethernet Shield |
| | Connector shield | Chassis Ground (Outer Cable Shield) |

In another example, the connector J40 is a dual port Ethernet Aux connector, whose pins are assigned as shown in Table 2.

TABLE 2
Dual Port Ethernet Aux Connector

| Pin Number | Signal Name | I/O Function Type |
|---|---|---|
| 1 | Quad Shield | Ethernet Shield (.01 uF to Chassis Gnd) |
| 2 | Rx2_Hi | Eth2 Differential 10/100 BaseT Input+ |
| 3 | NC | Not Connect |
| 4 | Rx2_Lo | Eth2 Differential 10/100BaseT Input− |
| 5 | Rx1_Lo | Eth1 Differential 10/100BaseT Input− |
| 6 | Rx1_Hi | Eth1 Differential 10/100BaseT Input+ |
| 7 | Tx1_Lo | Eth1 Differential 10/100BaseT Output− |
| 8 | Tx1_Hi | Eth1 Differential 10/100BaseT Output+ |
| 9 | Tx2_Hi | Eth2 Differential 10/100BaseT Output+ |
| 10 | NC | Not Connect |
| 11 | Tx2_Lo | Eth2 Differential 10/100BaseT Output− |
| 12 | Quad Shield | Ethernet Shield (.01 uF to Chassis Gnd) |
| | Connect Shield | Chassis Ground (Outer Cable Shield) |

In yet another example, the connector J2 is a USB keyboard interface connector having the pin assignments shown in Table 3.

TABLE 3
USB Keyboard Interface Connector No 1 (External)

| Pin Number | Signal Name | I/O Function Type |
|---|---|---|
| J2-1 | USBVCC | USB Power Supply Line |
| J2-2 | USBDMNS1 | USB Data 1− |
| J2-3 | USBDPLS1 | USB Data 1+ |
| J2-4 | DGND | Digital Ground |

In yet another example, the connector J3 is a USB mouse/Game controller interface connector having the pin assignments shown in Table 4.

TABLE 4
USB mouse/Game Controller Interface Connector No 2 (External)

| Pin Number | Signal Name | I/O Function Type |
|---|---|---|
| J3-1 | USBVCC | USB Power Supply Line |
| J3-2 | USBDMNS2 | USB Data 2− |
| J3-3 | USBDPLS2 | USB Data 2+ |
| J3-4 | DGND | Digital Ground |

In yet another example, the connector J15 is a JTAG interface connector having the pin assignments shown in Table 5. The serial Debug Interface is part of the JTAG Interface Connector J15, and provides debugging capability to the internal processor of the SVDU.

TABLE 5
JTAG Interface Connector (Internal)

| Pin Number | Signal Name | I/O Function Type |
|---|---|---|
| J15-1 | RS-232-Rx | RS-232 Rx |
| 2 | GND | Ground |
| 3 | RS-232 Tx | RS-232 Tx |
| 4 | CPLD_TDO | CPLD_TDO |
| 5 | GND | Ground |
| 6 | CPLD_TDI | CPLD_TDI |
| 7 | RW_TDO | RW_TDO |
| 8 | GND | Ground |
| 9 | RW_TDI | RW_TDI |
| 10 | RW_TCK | RW_TCK |
| 11 | GND | Ground |
| 12 | NC | No Connect |
| 13 | +3.3 V | +3.3 V |
| 14 | SW_RESET_N | RESET Internal Processor |
| 15 | CPLD_TMS | CPLD_TMS |
| 16 | Soft +3.3 V | +3.3 pull up by 1K |
| 17 | RW_TMS | RW_TMS |
| 18 | GND | GND |
| 19 | RW_HALT_N | RW_HALT_N |

In yet another example, the connector J5 is a power/signal connector having the pin assignments shown in Table 6. The mating cable assembly connector is a standard D-sub, Receptacle, 9-Position Connector.

TABLE 6
Power/Signal Connector J5 Pin Assignments

| Pin Number | Signal Name | I/O Function Type |
|---|---|---|
| 1 | +32 V | +32 V input |
| 2 | +32 V | +32 V input |
| 3 | Reserve | Reserve |
| 4 | Reserve | Reserve |
| 5 | CHASSIS GND | CHASSIS GND |
| 6 | +32 V RTN | +32 V Return |
| 7 | +32 V RTN | +32 V Return |
| 8 | Reserve | Reserve |
| 9 | Reserve | Reserve |

It can thus be seen that a new and useful aircraft video display unit and system has been described. Note that there are many possible variations of the embodiments described herein that fall within the scope of the following claims. Additionally, every implementation and configuration described herein is meant to be an example only and should not be taken as limiting the scope of the claims. Also, note that the use of the article “a” in the context of describing the invention (especially in the context of the following claims) is to be construed to cover both the singular and the plural. Finally, the steps of all methods described herein can be performed in any suitable order unless otherwise indicated herein or otherwise clearly contradicted by context.

What is claimed is:

1. An aircraft passenger video display unit, the video display unit comprising:
a housing coupled to a portion of an aircraft cabin;
a local area network interface disposed at least partially within the housing;
a video decoder disposed within the housing, the video decoder performing steps comprising:
receiving video content via the network interface, and
decoding the video content;
a display screen coupled to the housing, the display screen performing steps comprising:
displaying the decoded video content, and
displaying a prompt indicating that a passenger should insert a magnetic card;
a magnetic card reader coupled to the housing, the magnetic card reader performing steps comprising:
receiving the magnetic card;
reading data from the magnetic card; and
transmitting the read data through the network interface.

2. The video display unit of claim 1, wherein the magnetic card is a credit card.

3. The video display unit of claim 1, wherein the video content describes an item for sale, the magnetic card is a credit card, and the data from the magnetic card that is transmitted through the network interface includes data that enables a passenger using the display unit to purchase the item.

4. The video display unit of claim 1, further comprising a touch screen interface coupled to the display screen, the touch screen interface performing steps comprising of receiving the passenger's selection of the video content.

5. The video display unit of claim 1, further comprising
a magnetic sensor coupled to the housing that generates a signal whenever it senses a magnetic field;
a backlight coupled to the display screen, wherein the video display unit turns the backlight off when it detects the signal generated by the magnetic sensor for at least a predetermined period of time.

6. The video display unit of claim 1, further comprising an audio interface that receives the connection of a headset.

7. The video display unit of claim 1, further comprising: an Ethernet switch disposed within the housing, and plurality of Ethernet ports exposed to the exterior of the housing, each of the plurality of Ethernet ports being communicatively linked to the Ethernet switch.

8. The video display unit of claim 1, further comprising:
an infrared transceiver that performs steps comprising
receiving infrared signals representing a selection by the passenger of one of a plurality of selections from a user interface displayed on the display screen,
converting the infrared signals into electrical signals,
transmitting the electrical signals,
and a processor that performs steps comprising
receiving the electrical signals,
transmitting data representing the user selection via the network interface.

9. The video display unit of claim 1, further comprising an external drive interface.

10. The video display unit of claim 1, further comprising a serial data port, wherein the video display unit receives application software code via the network interface and receives kernel software code via the serial data port.

11. A system for displaying video content to an aircraft passenger, the system comprising:
a video display unit attached to an interior portion of an aircraft, the video display unit comprising a display screen, a local area network interface, and an infrared transceiver, the video display unit performing steps comprising:
displaying a user interface on the display screen,
receiving, via the infrared transceiver, signals indicating a user selection of an item from the user interface, and
transmitting, via the network interface, data that is based at least in part on the user selection;
and a passenger control unit comprising an infrared transmitter, the passenger control unit performing steps comprising:
receiving a user input representing the user selection, and
transmitting the signals indicating the user selection to the video display unit.

12. The system of claim 11, further comprising a local area network located on the aircraft, and a server communicatively linked to the network, the server having stored thereon video content.

13. The system of claim 12, wherein the video content comprises a plurality of digitally formatted videos, wherein the user selection represents one of the plurality of videos, and wherein the video display unit performs steps comprising:
transmitting data representing the user selection to the server,
receiving, via the network interface, the selected video,
decoded the selected video, and
displaying the selected video on the display screen.

14. The system of claim 11, wherein the video display unit is one of a plurality of video display units, the system further comprising a seat electronics box, the seat electronics box comprising a network switch communicatively linked to the local area network, each of the plurality of video display units being communicatively linked to the seat electronics box via separate network links.

15. The system of claim 14, the seat electronics box further comprising an RF tap converts data received over the local area network into RF signals, the system further comprising an overhead display unit that receives the RF signals from the seat electronic box via the RF tap.

16. The system of claim 11, wherein the video display unit further comprises:
a magnetic sensor coupled to a housing of the video display unit, wherein the sensor generates a signal whenever it senses a magnetic field;
a backlight coupled to the display screen, wherein the video display unit turns the backlight off when it detects the signal generated by the magnetic sensor for at least a predetermined period of time.

17. The system of claim 11, wherein the video display unit further comprises a serial data port, wherein the video display unit receives application software code via the network interface and receives kernel software code via the serial data port.

18. The system of claim 11, wherein the video display unit further comprises:
a magnetic card reader performing steps comprising:
receiving an inserted magnetic card;
reading data from the magnetic card; and
transmitting the read data over the local area network through the network interface.

19. The system of claim 18, wherein the magnetic card is a credit card, and data transmitted over the local area network includes data for permitting a passenger to purchase video content.

20. A system for providing video content, the system being located on-board an aircraft, the system comprising:
a plurality of passenger seats;
a local area network;
a plurality of video display units, each video display unit of the plurality being located proximate to at least one of the plurality of passenger seats, each video display unit comprising:
a display screen;
a network interface communicatively linked to the local area network;
a maintenance interface;
a printed circuit board having disposed thereon a processor, the processor executing instructions that enable the processor to decode video signals;
a server communicatively linked to the local area network, the server transmitting encoded video signals over the local area network; and
wherein each of the plurality of video display units performs steps comprising:
receiving the encoded video signals via the network interface card;
the processor of the video display unit decoding the encoded video signals;
displaying the video content on the display screen;
receiving, via the maintenance interface, test signals; and
transmitting, via maintenance interface, responses to the test signals representing the status of the printed circuit board.
